(19) United States
(12) Patent Application Publication
(10) Pub. No.: US 2007/0124370 A1
(43) Pub. Date: May 31, 2007

(54) Interactive table based platform to facilitate collaborative activities

(75) Inventors: Krishnamohan R. Nareddy, Bothell, WA (US); Andrew D. Wilson, Seattle, WA (US); Yong Rui, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/289,671

(22) Filed: Nov. 29, 2005

(51) Int. Cl. G06F 15/16

(52) U.S. Cl. 709/204

(57) ABSTRACT

A unique system and method that facilitates multi-user collaborative interactions is provided. Multiple users can provide input to an interactive surface at or about the same time without yielding control of the surface to any one user. The multiple users can share control of the surface and perform operations on various objects displayed on the surface. The objects can undergo a variety of manipulations and modifications depending on the particular application in use. Objects can be moved or copied between the interactive surface (a public workspace) and a more private workspace where a single user controls the workspace. The objects can also be grouped as desired

### BACKGROUND

Most traditional computing environments are designed around a single active user. Based on the hardware design of any desktop computer or laptop, for example, the conventional PC tends to be optimized for use by one user. Operating systems and other software applications usually allow only one user to control the desktop and any virtual objects on the desktop at any given time. Multiple users attempting to simultaneously manipulate the desktop, for instance, in the pursuit of accomplishing a collaborative task have to follow a protocol to yield to each other to work around the single user limitation as they take turns to manipulate the desktop.

Alternatively, they may work on different desktops with different views of the same document, which have to be subsequently merged to maintain a unified synchronized view. Both options are relatively problematic for several reasons. In particular, much time may be wasted while users wait for their turn or find a mutual time to meet and merge the documents. Additional errors may be introduced while merging documents. When relying on multiple computers, some may incur application conflicts, machine errors, or network disconnection, resulting in lost data and other related complications.

Gaming technology allows for more than one person to actively participate but these types of applications are substantially limited. Web-based programs also permit more than one user, but here, the users are often located at disparate locations and thus, apart from one another, which can introduce further difficulties when working together on a project.

### SUMMARY

The following presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

The subject application relates to a system(s) and/or methodology that facilitate multi-user collaborative interactions with respect to virtual objects on a common interactive work surface. In particular, more than one user can interact with one another in a collaborative manner using the same work surface without having to yield control of the work surface. This can be accomplished in part by managing the inputs from users and carrying them out independently of each other but at the same time if necessary. More specifically, multiple inputs from multiple users can be controlled according to the object to which the input pertains or relates. That is, a first object can be saved by a first user at or about the same time a second user prints a second object such that neither user relinquishes control of the workspace or surface.

In practice for example, two users Shane and Tom may be teamed together to design a new art exhibit for a group of nationally known artists. They are each responsible for different parts of the exhibit but want to integrate their individual inputs into one cohesive plan before presenting it to the gallery owner. Each user can render their art images onto the surface as well as any design elements they want to include such as signage and display stands. On the same surface, Shane can manipulate his set of images while Tom is manipulating his images. Hence, Tom and Shane may act on their images at the same time or at different times where there may or may not be overlap between their actions.

Examples of manipulations include but are not limited to moving, enlarging, rotating, or re-sizing the objects (e.g., images) for easier viewing on the surface and/or annotating notes, comments or other attachments thereto. The annotations can be in written or audio form and can appear either hidden or visible with respect to the corresponding object. Furthermore, some manipulations can be performed at the same time to increase user efficiency. Many other operations can be performed on the objects include but are not limited to copy, paste, replicate, restore, visual appearance modification (e.g., color, font, font size, etc.), open, close, and scroll. Graphical intuitive menus can be presented to the user to display many of these operations and commands.

The interactive work surface can provide several user interface elements and a common set of user interaction operations for the user. For instance, the interactive surface can render or display one or more virtual objects individually or grouped into collections. Such objects can be employed in various types of applications. Examples of objects include images, photographs, sound or audio clips, video, and/or documents. The objects can share the available workspace without conflict assuming that reasonable social manners and norms are followed as they are in the paper environment. That is, rarely would one person grab and discard a paper (hard copy) that another person was reading. The same may be said in the virtual environment. It is very unlikely for a user to delete an object that another user is currently reading, viewing, or otherwise working with.

As mentioned above, the objects can undergo various manipulations by the users. These manipulations can be carried out using natural gestures. In particular, the interactive surface can be touch-sensitive and receive input by hand or stylus as well as by keyboard, mouse, microphone, or other input device. The surface itself can also be employed to assimilate specially tagged physical objects into the virtual environment. For example, a photograph that has been tagged can be recognized by way of the tag by the interactive surface and then digitized to become a virtual image. The virtual image can then be saved or otherwise manipulated like any other virtual object rendered on the surface.

As mentioned above, the interactive work surface is a common workspace for multiple users. Thus, it can be considered a public workspace where objects are visible and subject to manipulation or modification by any user with access to the workspace. There may be instances, however, where one or more of the users may desire to interact with some of the objects in a more private manner such as on a laptop or other personal computing device. Objects can be readily moved between the public and private workspaces using a command (e.g., icon or other user interface element representing each of the public and private workspaces).

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a system that facilitates multi-user collaborative interactions with an interactive surface.

FIG. 2 is a block diagram of a system that facilitates navigation of objects by one or multiple users when interacting with objects rendered on an interactive surface in a collaborative manner.

FIG. 3 is a block diagram of various navigational components that can be employed to manipulate various objects displayed on an interactive surface.

FIG. 4 is a block diagram demonstrating an exemplary collaborative interaction between multiple users and their objects on an interactive surface.

FIG. 5 is a block diagram demonstrating an exemplary collaborative interaction between multiple users and their objects on an interactive surface.

FIG. 6 is a block diagram that depicts an exemplary manipulation of an object rendered on an interactive work surface.

FIG. 7 is a block diagram that follows from FIG. 6 and illustrates a resulting view of the object after such manipulation.

FIG. 8 is a block diagram demonstrating a collaborative interaction between two users to create a new object collection on the interactive work surface.

FIG. 9 is a block diagram that follows from FIG. 8 to illustrate the movement or copying of objects existing on the surface by the users to a new collection form.

FIG. 10 is a block diagram that follows from FIG. 9 to illustrate a new collection of objects created by the users using objects previously rendered on the interactive surface.

FIG. 11 is a block diagram that illustrates the movement of objects between public and private workspaces.

FIG. 12 is a block diagram that illustrates an exemplary client-server relationship between the private and public workspaces.

FIG. 13 is a block diagram that illustrates an exemplary client-server relationship between the private and public workspaces.

FIG. 14 is a flow chart illustrating an exemplary methodology that facilitates multi-user collaborative interactions with respect to an interactive work surface.

FIG. 15 illustrates an exemplary environment for implementing various aspects of the invention.

### DETAILED DESCRIPTION

The subject systems and/or methods are now described with reference to the drawings, wherein like reference numerals are used to refer to like elements throughout. In the following description, for purposes of explanation, numerous specific details are set forth in order to provide a thorough understanding of the systems and/or methods. It may be evident, however, that the subject systems and/or methods may be practiced without these specific details. In other instances, well-known structures and devices are shown in block diagram form in order to facilitate describing them.

As used herein, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject systems and/or methods can incorporate various inference schemes and/or techniques in connection with recognizing and identifying private computing devices and ritualistic or routine interactions between the private devices and a public interactive surface component. For example, an exemplary interactive surface component can learn to perform particular actions or display certain information when one or more particular users are identified to be interacting with the surface. In practice, for instance, imagine that when John signs on to the work surface, the surface can open or bring up John's last saved project (e.g., one or more objects) and/or load John's preferences. Since multiple users can sign on to and use the surface, multiple user profiles or preference settings can be loaded as well. For example, John's work can appear in blue Times New Roman font as he prefers whereas Joe's work can appear in black Arial font.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

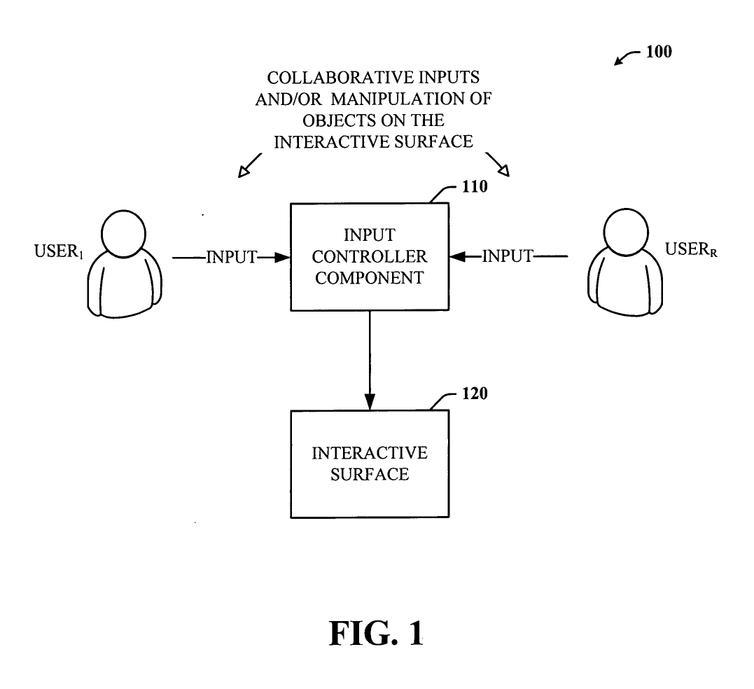

Referring now to FIG. 1, there is a general block diagram of a system 100 that facilitates collaborative interactions by multiple users with respect to an interactive surface. The system 100 includes an input controller component 110 that can receive input from multiple users at or about the same time and carry them out in a controlled manner so that the desired actions occur or desired results appear on the interactive surface 120. In particular, each user's input can be carried out independently of the other regardless of whether they were received at the same time, overlapping one another or at different times.

For example, a first user (USER₁) can input a command: “open object named farm-design”. A second user (USER_{R}, where R is an integer greater than 1) can input the same command as the first user. To mitigate conflicts between user commands in this instance, the system can open copies of the object and ask each user if they would like to merge any changes into one document or if not, require them to save the object under a new name. In other scenarios where the inputs are different but occur near or at the same time, the input controller can carry them out as they are received. Thus, if the inputs “save object B” and “print object D” are received at exactly the same time by the first and second users, respectively, then they can be processed at the same time. That is, as object B is being saved, object D is printed, or vice versa. Hence, multiple users can retain control of the desktop, and in particular, can perform a wide variety of operations on objects on the surface at or about the same time without yielding control of the surface to any one user.

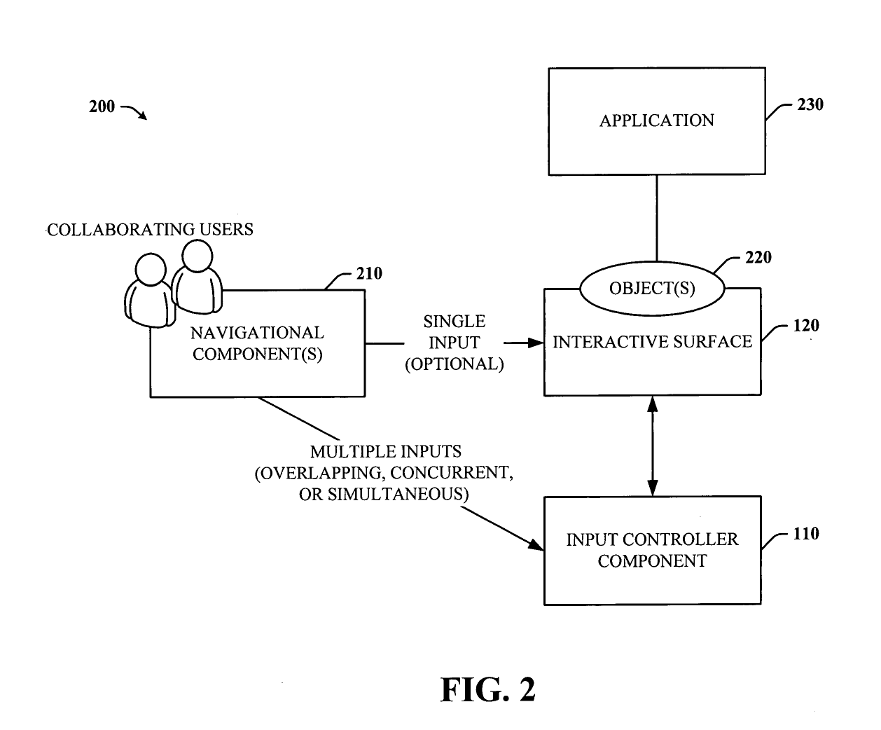

Referring now to FIG. 2, there is a block diagram of a system 200 that facilitates navigation of objects by one or multiple users when interacting with objects rendered on an interactive surface in a collaborative manner. The system 200 includes one or more navigational components 210 that can recognize natural gestures made by (collaborating) users as well as traditional forms of navigation using on screen commands or buttons or other user interface elements. The navigational components can provide input to the interactive surface 120 by way of the input controller component 110. Multiple inputs that are submitted or received at the same time, near the same time or at overlapping times can be controlled by the input controller component 110 and then communicated to the interactive surface 110.

Such inputs can involve performing one or more operations on a set of objects 220 that may be rendered on the surface 120. Each object can represent a single entity and can be employed in any application 230. For example, an object in a photo sharing or sorting application can represent a photograph. In a word processing application, the object can represent a letter or other document. The object can have any amount of data associated with it. In addition, it can have annotations such as attachments or comments associated therewith.

The application 230 can determine the manner and appearance in which the object is rendered and associate certain behaviors to it as well. For example, a sound object can be “played” but options relating to appearance would not be useful and thus may not be offered to the user. However, the reverse may be true for a 2-dimensional image. Furthermore, the application 230 can also determine what data to associate with the object and how to use that data.

Regarding data persistence, the application 230 can be responsible for persisting all objects in a given application session. For example, if a user created ten photos and annotated them during a session, the application 230 can save data associated with each object along with the layout information of the session. Later, this saved data can be used to restore the session so users can continue working with the application and their session data. Also, all or substantially all data can be saved to a single file. Each object can have individual files associated with it. For example, a photo object has an image file. All (or substantially all) the files referenced by the object and the data file can be stored in one cab file. This ensures that all data needed for a session stays together and can be moved as one entity.

Regardless of the type of application, there are many common operations that users can perform on objects displayed on the interactive surface. As previously mentioned, the operations can be initiated with gestures such as sliding a finger across the table's surface. However, they can also be initiated using special pointing devices or speech commands. For example, a user can utilize a pointer marked with a specific pattern visible to the surface's camera (not shown) to initiate operations on an object. In addition, users can point to objects (with fingers or patterned pointing devices) as well as issue speech commands to affect behavior of objects on the surface.

The operations can include but are not limited to the following:

Create

Update

Destroy

Launch Context Sensitive Menu

Move

Slide

Drag and Drop

Rotate

Resize

Restore

Minimize

View (Summary view)

Select

Multiple Select

Deselect

Deselect Multiple Selection

Edit

View (full view)

Save

Delete

Print

Add a web link

Add text attachment

Add generic file attachment

Add speech attachment

Browse web link

Browse text attachment

Browse generic file attachment

Listen to speech attachment

Delete a web link

Delete text attachment

Delete generic file attachment

Delete speech attachment

Crop

Scroll contents (in 2- or 3-dimension)

Slide object out

Rotate collection object

Zoom in/out.

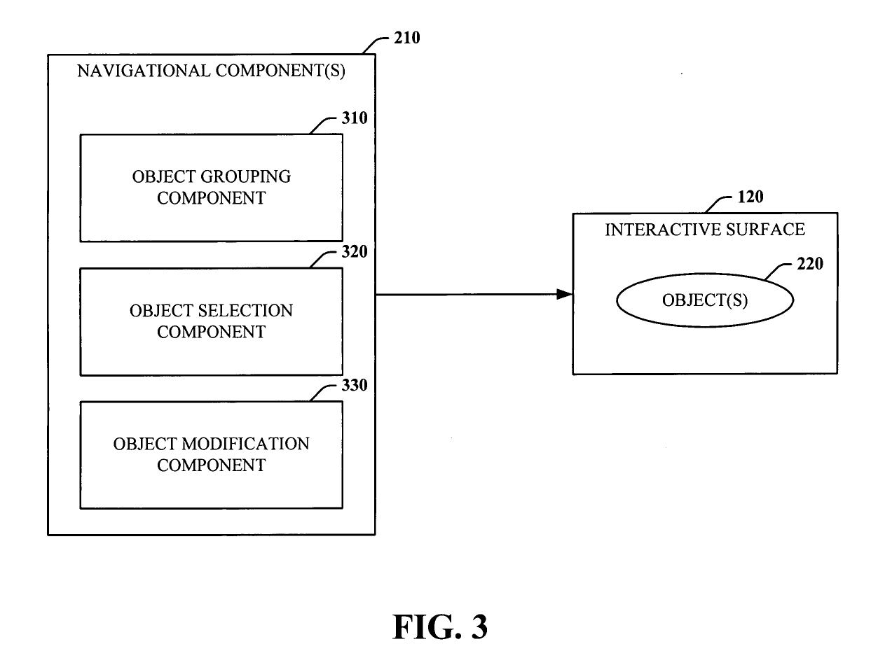

Turning now to FIG. 3, there is a block diagram of various navigational components 210 that can be employed to manipulate various objects 220 displayed on the interactive surface 120. As desired by the users, an object grouping component 310 can be employed to group a plurality of objects 220 together to form a collection of objects. Multiple objects can be selected or deselected using an object selection component 320, and objects can be modified or edited via an object modification component 330. Many other navigational components that are not shown can also be available to the users in order to perform various operations listed above.

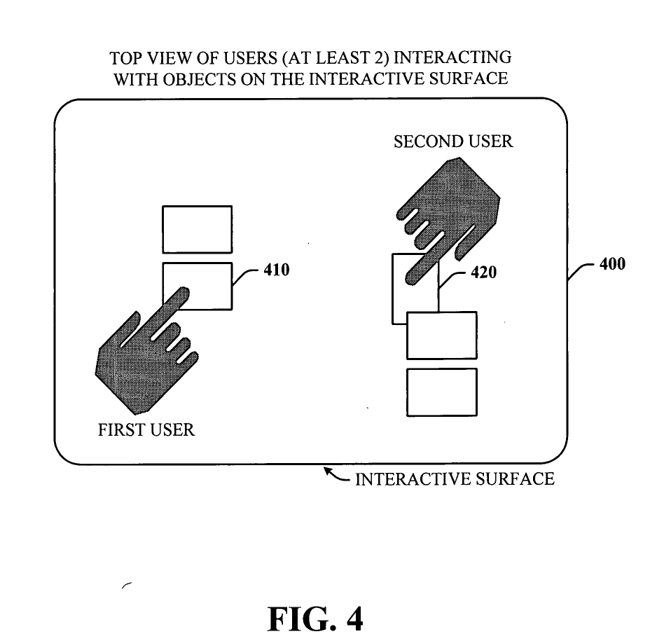

In FIGS. 4-11 that follow, a few exemplary scenarios are demonstrated to illustrate multiple users interacting in a collaborative manner on objects rendered on the interactive surface. Beginning with FIG. 4, a top view looking down on at least two users interacting with objects 410, 420 displayed on the surface 400 is shown. In this scenario, a first user is pointing to or touching one object 410 and a second user is pointing to or touching another object 420. In other words, both users have shared control of the surface 400. Based on the organization of the objects, it may be that the first user has positioned his objects (those created by him) in one area of the surface 400 and the second user has done the same with her objects in another area of the surface 400; however, the objects can be moved around to any position on the surface 400. Though the diagram in FIG. 4 is described as a top view of the surface 400, it should be appreciated that the surface may be vertically oriented as well such that multiple users could stand or sit in front of the surface.

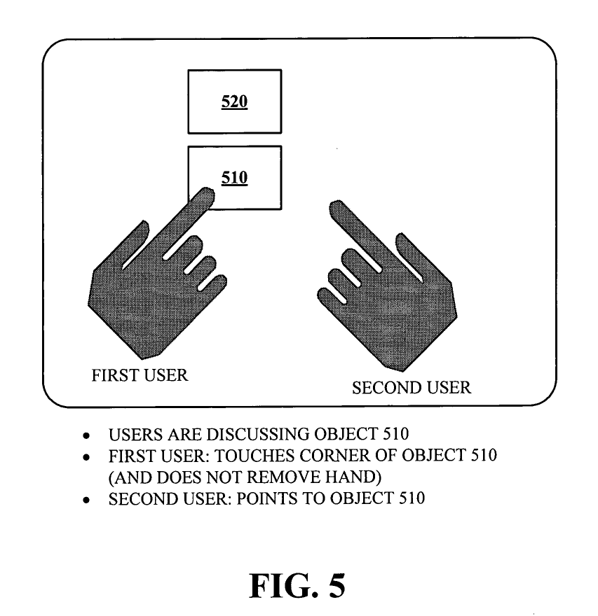

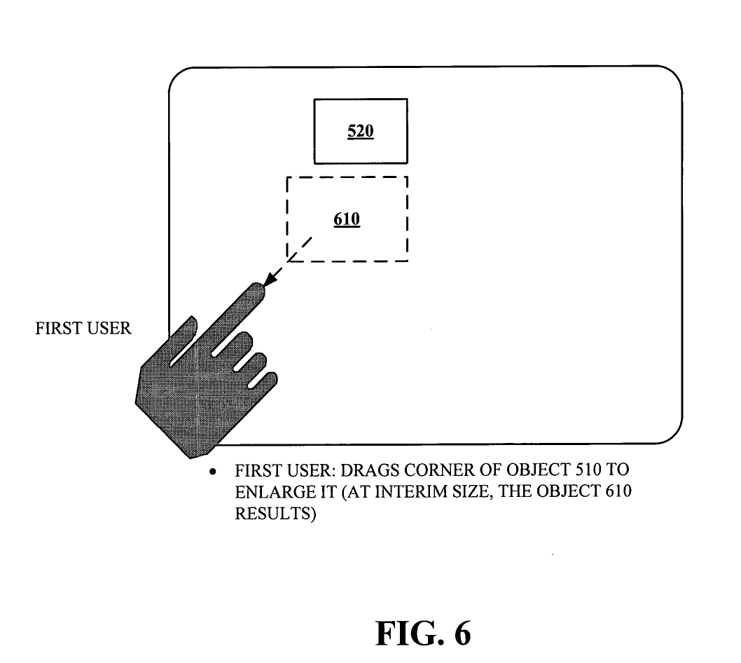

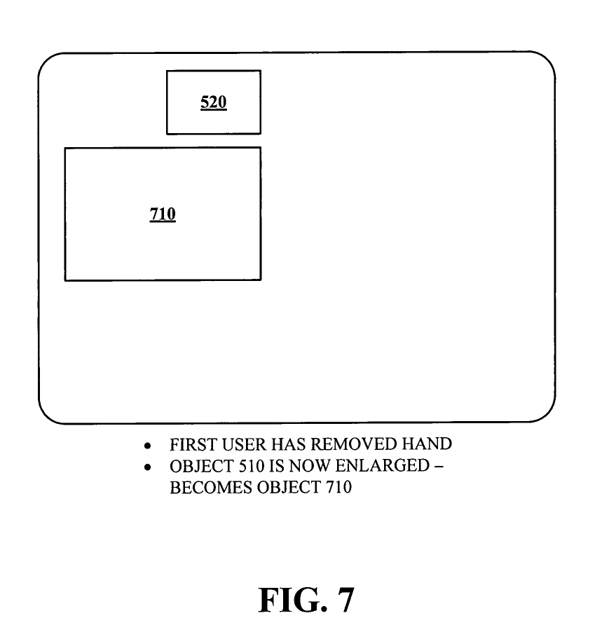

In FIG. 5, the first and second users are now interacting with two objects 510, 520. For example, imagine that these users are discussing the object 510 and that the first user is touching the corner of the object 510 as shown. FIG. 6 represents a sequential view of the object 510 as it now appears larger in size (object 610) as the first user drags his finger in a downward diagonal manner to enlarge the object 510. When the first user stops dragging the corner of the object 610 with his finger, the object 710 results as illustrated in FIG. 7.

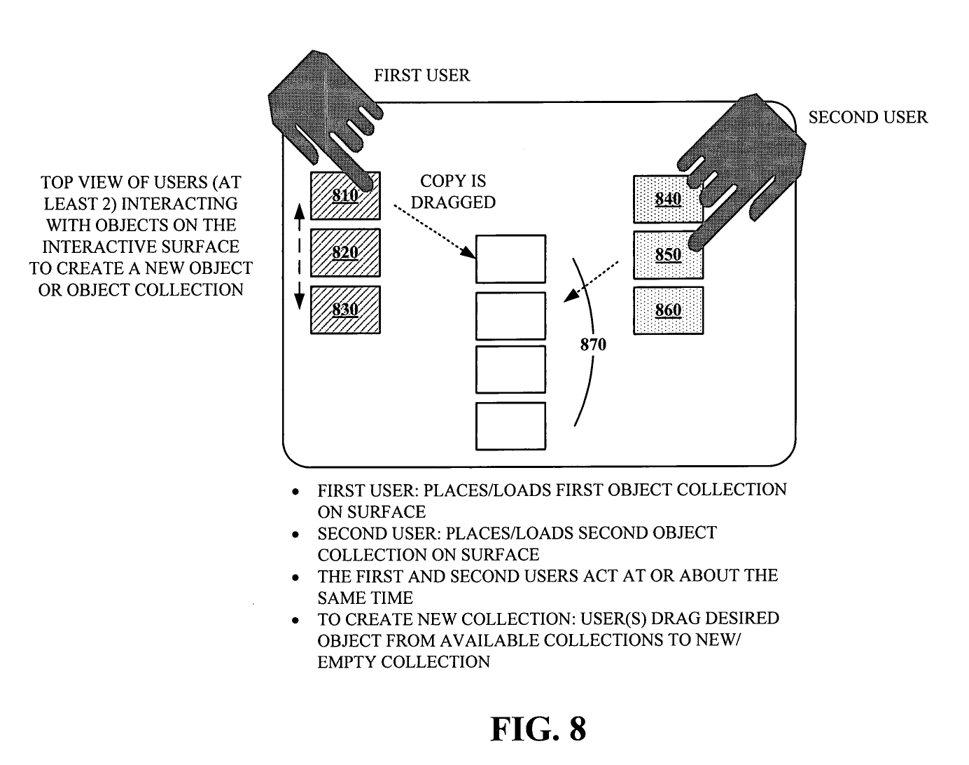

Turning now to FIG. 8, another sequence of multi-user interactions is illustrated. In particular, at least a first and a second user are interacting with their respectively owned collection of objects to create a new collection of objects. For instance, imagine that the objects are slides that are prepared for a presentation. Each user may have created their own set of slides based on their expertise and knowledge of the subject matter but now need to integrate them to create a complete slide deck.

The first user places or loads his slides 810, 820, 830 (first object collection) onto the surface at or about the same time as the second user places his collection of slides 840, 850, 860 onto the surface. An empty slide deck 870 (e.g., shell) having the number of slides desired by the users appears on the surface as well to facilitate the creation of the new deck. The number of slides can be changed by the user but initially, the users can set up the shell to guide them along in their work.

Different approaches can be employed to create the new slide collection based on the preexisting slides. According to one approach, a copy of any slide can be dragged to the new collection and placed in the appropriate position (e.g., slide 1, slide 2, etc.). Hence, the user's original collection does not change. Alternatively, the original slide rather than a copy can be dragged to the new collection, thereby causing a change to the original collection. The user and/or the application can determine the behavior of the objects or slides in this case.

As depicted in FIG. 8, the first user is dragging the object 810 and the second user is dragging the slide 850 to the new collection. The users can perform these actions at or about the same time or in a sequential manner (e.g., one after the other) as they continue to collaborate on the creation of the new slide deck without either user losing or foregoing control of the surface at any time.

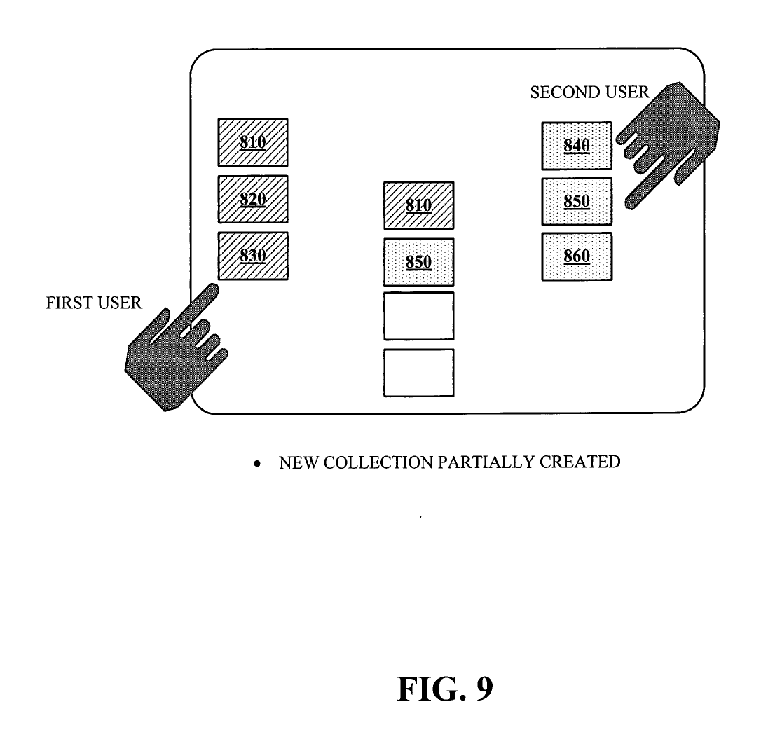

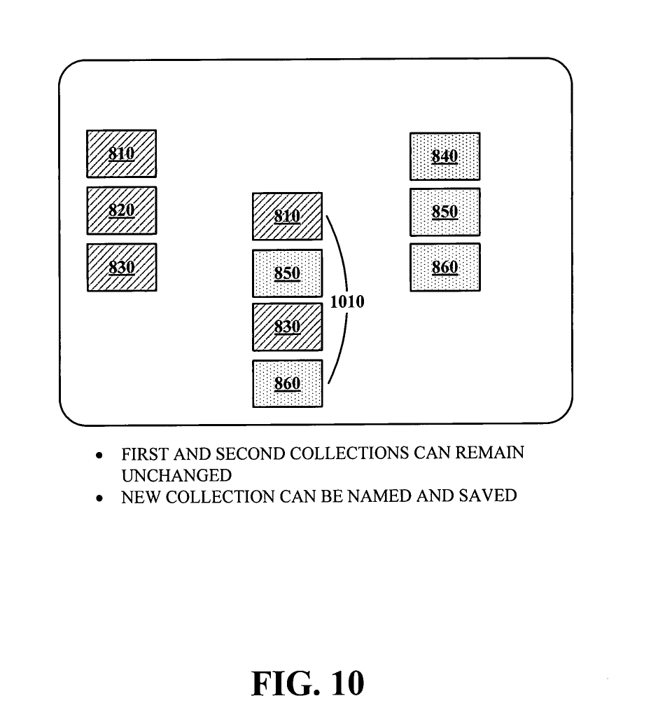

FIG. 9 follows from FIG. 8 to illustrate the movement or copying of the selected slides 810, 850 to the new slide deck shell 870. In FIG. 10, a completed slide deck 1010 is shown. The new collection 1010 can be named and saved as desired by the collaborating users. Other modifications can be performed as well to finalize the slide deck for presentation. In some cases, the project at hand may need more time and work by the users; and for creative reasons, they may choose to spend some time on their own using their personal resources and expertise and meet again to share their ideas and thoughts. To accomplish this, the users can move or copy any objects on the surface to their personal computing device or private workspace.

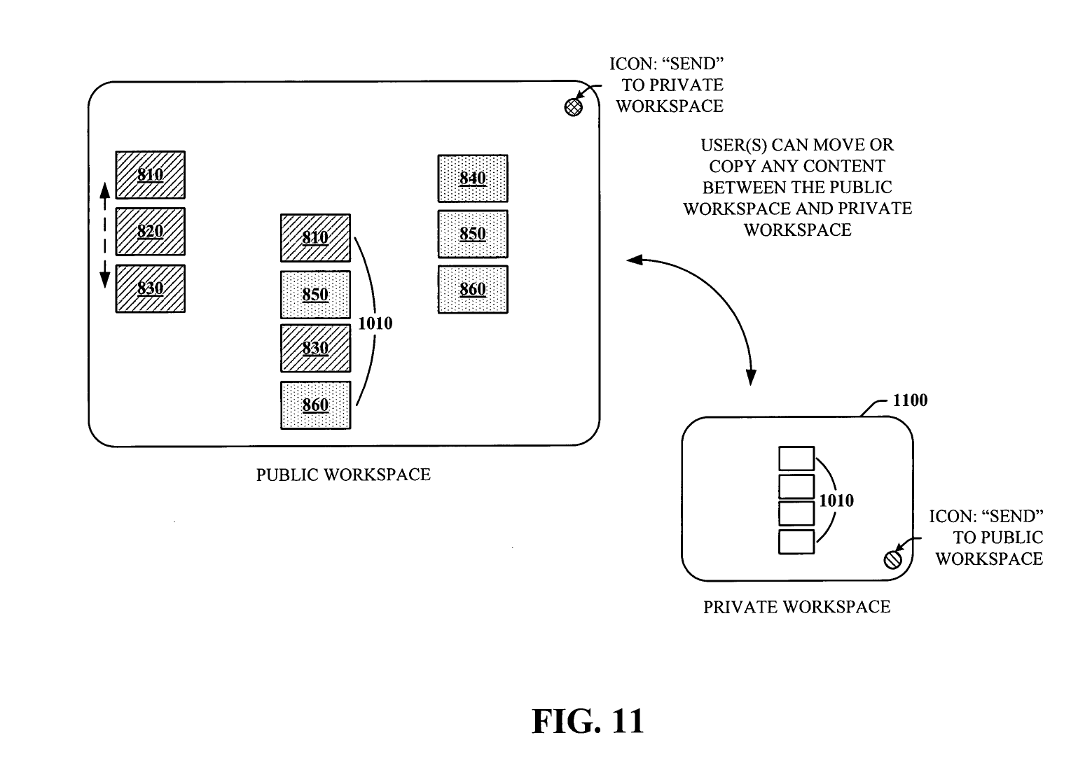

FIG. 11 demonstrates the movement or copying of the new slide deck 1010 to at least one private workspace 1100 (e.g., laptop). In general, objects or collections of objects can be moved between the public environment of the interactive surface and a user's private workspace by way of an icon or other user interface element. For example, the user can select the desired objects and then drag and drop them on the icon. Both the interactive surface and the private workspace can employ similar commands or icons to make the transfer of objects clean and seamless. When objects are moved to the private workspace, the user can perform operations on the objects without explicit interaction by other users. The “owner” of the private workspace maintains control of the workspace whereas control is shared among the users in the public workspace.

Though only one private workspace is depicted in FIG. 11, it should be appreciated that multiple private workspaces can be maintained in this collaborative environment. The collaborative system (e.g., interactive surface and operating software) can maintain and manage the binding between a user's private workspace and their corresponding proxy (e.g., icon) rendered on the interactive surface. For example, multiple users may each be using one or more than one private workspaces (e.g., laptop and PDA) in conjunction with the interactive surface. Each private workspace can be associated with its own icon or other proxy on the interactive surface so that the collaborating users can efficiently manage any information passed or shared between their particular workspaces and the interactive surface.

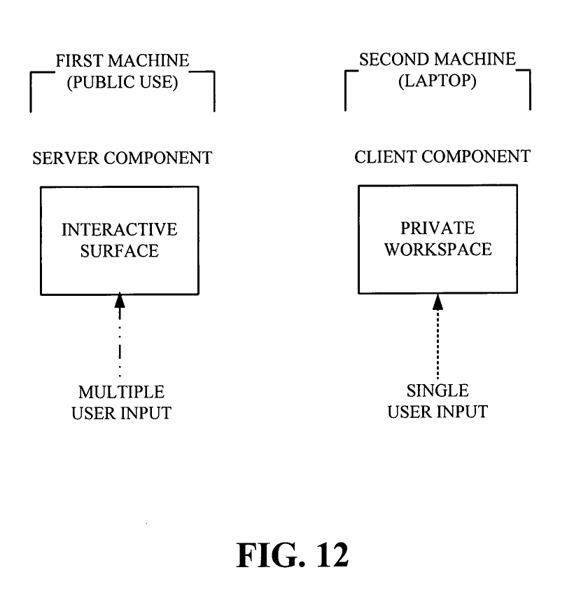

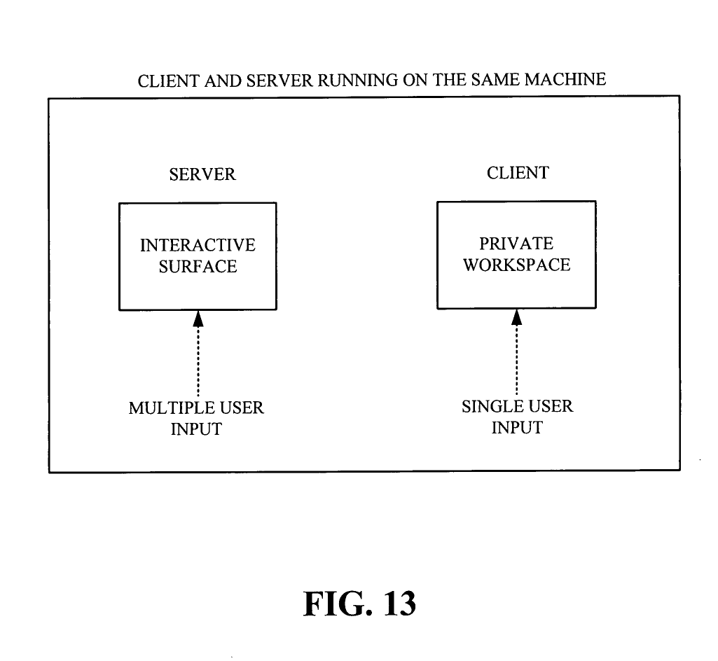

Turning now to FIGS. 12 and 13, there are block diagrams that illustrate exemplary client-server relationships as they relate to private (e.g., personal user machine) and public workspaces (e.g., interactive surface). Generally speaking, all applications can be expected to have a client component and a server component. The client can be considered private workspace and thus controlled by a single user. The server can be considered public workspace and can be used and controlled by multiple users, often simultaneously. Some users may prefer the arrangement illustrated in FIG. 12 and decide to run the client on a notebook computer and treat it as private workspace while treating the surface as public workspace. However, the client and server components should be able to run on the same machine (the machine attached to the surface) as indicated in FIG. 13.

Various methodologies will now be described via a series of acts. It is to be understood and appreciated that the subject system and/or methodology is not limited by the order of acts, as some acts may, in accordance with the subject application, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject application.

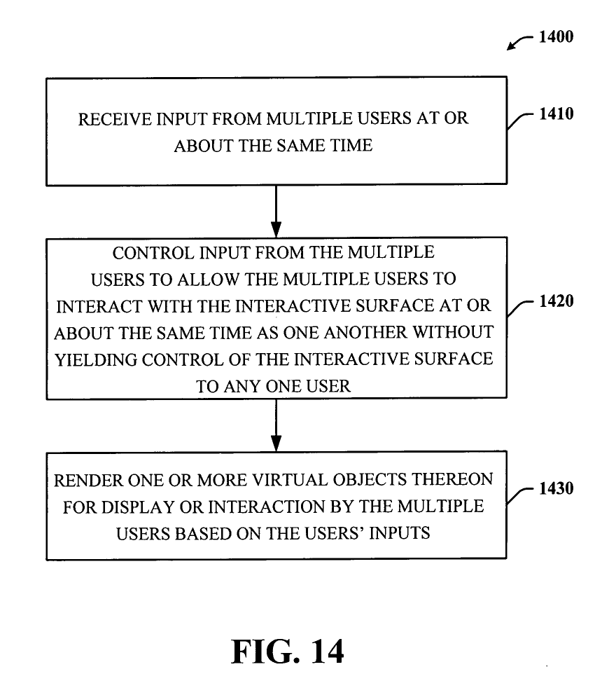

FIG. 14 is a flow chart illustrating an exemplary method 1400 that facilitates multi-user collaborative interactions with respect to an interactive work surface. The method 1400 involves receiving input from multiple users at or about the same time at 1410. At 1420, the input from the multiple users can be controlled by an input controller component to allow the users to interact with any of the objects on the interactive surface at or about the same time as one another. In particular, the inputs are carried out independently of the others thus any number of users can interact with the surface at or about the same time. At 1430, one or more virtual objects on the surface can be rendered based at least in part on the users' inputs.

Moreover, the systems and methods provided herein facilitate collaborative activities where joint decision making and joint responsibility are involved. Users can readily and easily provide their input at any time with respect to the other users without losing control of objects they may be working with on the interactive surface. That is, control of this public workspace is effectively shared among the participating users assuming that reasonable social norms and behaviors are followed as they would in the physical working environment (e.g., where hard copies of papers, books, etc. are employed).

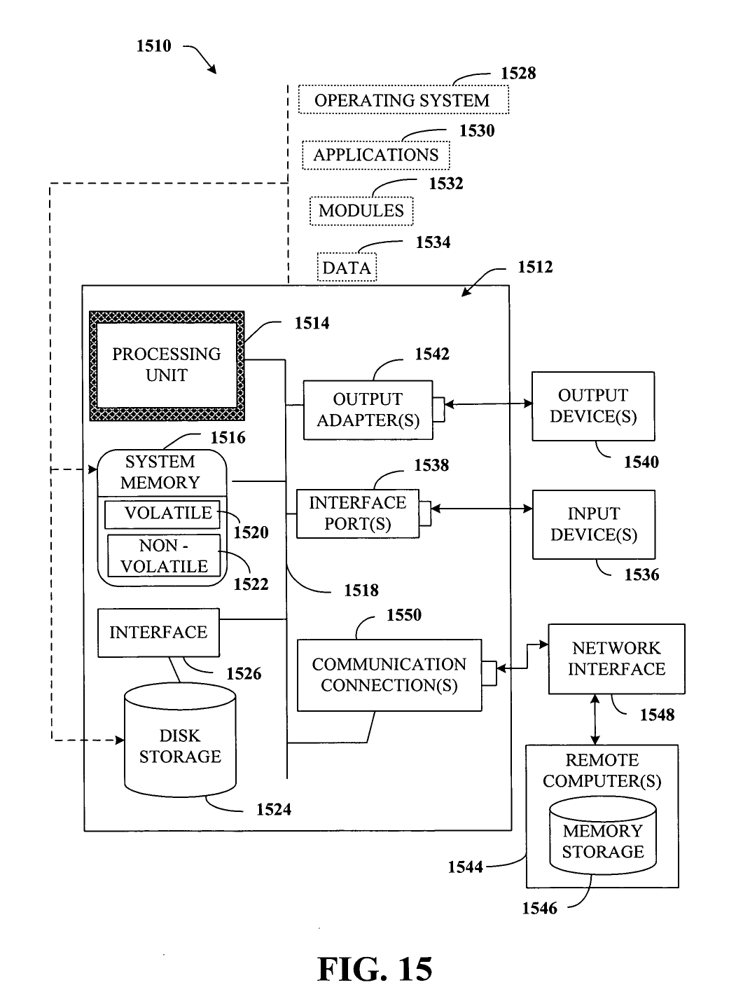

In order to provide additional context for various aspects of the subject application, FIG. 15 and the following discussion are intended to provide a brief, general description of a suitable operating environment 1510 in which various aspects of the subject application may be implemented. While the system(s) and/or method(s) is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1510 is only one example of a suitable operating environment and is not intended to suggest any limitation as to the scope of use or functionality of the system and/or method. Other well known computer systems, environments, and/or configurations that may be suitable for use with the system and/or method include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 15, an exemplary environment 1510 for implementing various aspects of the system and/or method includes a computer 1512. The computer 1512 includes a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable ROM (EEPROM), or flash memory. Volatile memory 1520 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1512 also includes removable/nonremovable, volatile/nonvolatile computer storage media. FIG. 15 illustrates, for example a disk storage 1524. Disk storage 1524 includes, but is not limited to, devices like a magnetic disk drive, floppy disk drive, tape drive, Jaz drive, Zip drive, LS-100 drive, flash memory card, or memory stick. In addition, disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface is typically used such as interface 1526.

It is to be appreciated that FIG. 15 describes software that acts as an intermediary between users and the basic computer resources described in suitable operating environment 1510. Such software includes an operating system 1528. Operating system 1528, which can be stored on disk storage 1524, acts to control and allocate resources of the computer system 1512. System applications 1530 take advantage of the management of resources by operating system 1528 through program modules 1532 and program data 1534 stored either in system memory 1516 or on disk storage 1524. It is to be appreciated that the subject system and/or method can be implemented with various operating systems or combinations of operating systems.

A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512 and to output information from computer 1512 to an output device 1540. Output adapter 1542 is provided to illustrate that there are some output devices 1540 like monitors, speakers, and printers among other output devices 1540 that require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1550 refers to the hardware/software employed to connect the network interface 1548 to the bus 1518. While communication connection 1550 is shown for illustrative clarity inside computer 1512, it can also be external to computer 1512. The hardware/software necessary for connection to the network interface 1548 includes, for exemplary purposes only, internal and external technologies such as, modems including regular telephone grade modems, cable modems and DSL modems, ISDN adapters, and Ethernet cards.

What has been described above includes examples of the subject system and/or method. It is, of course, not possible to describe every conceivable combination of components or methodologies for purposes of describing the subject system and/or method, but one of ordinary skill in the art may recognize that many further combinations and permutations of the subject system and/or method are possible. Accordingly, the subject system and/or method are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An operating system that facilitates multi-user collaborative interactions comprising:
an interactive surface component that renders one or more virtual objects thereon for display or interaction by multiple users based in part on user inputs; and
an input controller component that controls the inputs from the multiple users to allow the multiple users to interact with the one or more virtual objects on the interactive surface component at or about the same time without yielding control of the interactive surface component to any one user.

2. The system of claim 1, the input controller carries out each input received from each user independently of any other input received at or about the same time such that control of the interactive surface component is shared among the multiple users.

3. The system of claim 1 further comprises one or more navigational components that facilitate manipulation of the virtual objects rendered on the interactive surface component.

4. The system of claim 1 further comprises at least one personal computing device that is virtually connected to the interactive surface component in order to move or copy one or more virtual objects between the interactive surface component and the personal computing device.

5. The system of claim 1, the interactive surface component is located on a server component.

6. The system of claim 1 further comprises an object modification component that modifies at least one of an appearance and content of the one or more virtual objects.

7. The system of claim 1 further comprises an object grouping component that groups a plurality of objects into a collection.

8. The system of claim 7, the collection behaves like a single entity or object such that an operation performed on the collection effects a change to each object included therein.

9. The system of claim 1, the interactive surface component is oriented in a horizontal manner.

10. The system of claim 1 whereby one or more operations can be performed on the collection as a single entity to effect a desired change on each object included therein.

11. The system of claim 1, the interactive surface component comprises a public workspace and allows multiple users to interact with different objects displayed thereon at or about the same time.

12. A user interface that facilitates collaboration among multiple users comprising:
an interactive surface that renders one or more virtual objects based at least in part on an application in use;
one or more navigational components that facilitate navigation and viewing of the virtual objects; and
one or more input components that receive multiple inputs from multiple users and that operate independently of each other so that control of the interactive surface is shared among the multiple users.

13. The user interface of claim 12 further comprises one or more user interface elements that facilitate manipulation of the one or more virtual objects.

14. The user interface of claim 12 is oriented horizontally and scaled to optimize interaction with multiple users.

15. A method that facilitates multi-user collaborative interactions on an interactive surface comprising:
receiving input from multiple users at or about the same time;
controlling the inputs from the multiple users to allow the multiple users to interact with the one or more virtual objects on an interactive surface at or about the same time without yielding control of the interactive surface to any one user; and
rendering the one or more virtual objects based at least in part on the users' inputs.

16. The method of claim 15 further comprises modifying the one or more virtual objects to alter how the objects are rendered.

17. The method of claim 15 further comprises grouping multiple objects to create at least one collection of objects.

18. The method of claim 17 further comprises performing at least one action on the collection to effect the action on each object included therein.

19. The method of claim 15 further comprises moving one or more virtual objects from the interactive surface to a private workspace to gain single user control.

20. The method of claim 15 further comprises performing one or more operations on the one or more virtual objects in an independent manner at or about the same time according to when such input is received from the users.
